(19) United States
(12) Patent Application Publication
(10) Pub. No.: US 2018/0313495 A1
(43) Pub. Date: Nov. 1, 2018

(54) GREASE GUN COUPLER WITH INTEGRATED PRESSURE RELIEF VALVE

(71) Applicant: SKR Industries, LLC, Roswell, GA (US)

(72) Inventors: DAVID A. SWANSON, KALAMAZOO, MI (US); DENNIS R. RODENROTH, ROSWELL, GA (US); BRENT KNOLL, BRENTWOOD, TN (US)

(21) Appl. No.: 14/955,876

(22) Filed: Dec. 1, 2015

(51) Int. Cl. F16N 5/02; F16N 3/12; F16N 21/04

(52) U.S. Cl. CPC F16N 5/02; F16N 2270/60; F16N 21/04; F16N 3/12

(57) ABSTRACT

A grease gun coupler with integrated pressure relief valve configured to attach a grease gun to a grease fitting includes a main body with a fluid conduit defined therethrough, and a pressure relief valve integrally formed with the main body extending generally perpendicularly therefrom.

### BRIEF DESCRIPTION OF THE DRAWINGS

The disclosed grease gun coupler is described with reference to the accompanying drawings. In the drawings, like reference numbers indicate identical or functionally similar elements. Additionally, the left-most digits of a reference number identifies the drawing in which the reference number first appears.

FIG. 1 is an side elevation view of an exemplary grease coupler;

FIG. 2 is a top plan view of the exemplary grease coupler of FIG. 1;

FIG. 3 is an exploded view of the exemplary grease coupler of FIG. 1;

FIG. 4 is a section view of the grease coupler of FIG. 1 along line A-A as indicated in FIG. 2;

FIG. 5 is another section view of the grease coupler of FIG. 1 showing engagement with a grease fitting;

FIG. 6 is a section view of an alternative exemplary embodiment of a grease coupler with a main body having an integrally-formed ball carrier; and

FIG. 7 is a section view of a further alternative embodiment of the grease coupler main body having an integrally-formed pressure relief valve assembly.

### DETAILED DESCRIPTION

The various embodiments of the grease gun coupler and their advantages are best understood by referring to FIGS. 1 through 7 of the drawings. The elements of the drawings are not necessarily to scale, emphasis instead being placed upon clearly illustrating the novel features and principles of operation. Throughout the drawings, like numerals are used for like and corresponding parts of the various drawings.

Furthermore, reference in the specification to “an embodiment,” “one embodiment,” “various embodiments,” or any variant thereof means that a particular feature or aspect described in conjunction with the particular embodiment is included in at least one embodiment. Thus, the appearance of the phrases “in one embodiment,” “in another embodiment,” or variations thereof in various places throughout the specification are not necessarily all referring to its respective embodiment.

For purposes of description herein, the terms “upper,” “lower,” “right,” “left,” “rear,” “front,” “vertical,” “horizontal,” and synonyms or derivatives thereof shall be understood to be with respect to how the coupler is installed on a grease gun. As described in greater detail below, the end of the coupler that is attachable to a grease gun will be referred to as the “rear end” of the coupler, while the end attachable to a grease fitting will be referred to as the “front end.” However, it is to be understood that the invention may assume various alternative orientations and step sequences, except where expressly specified to the contrary. It is also to be understood that the specific devices and processes illustrated in the attached drawings, and described in the following specification are exemplary embodiments of the inventive concepts defined in the appended claims. Hence, specific dimensions and other physical characteristics relating to the embodiments disclosed herein are not to be considered as limiting, unless the claims expressly state otherwise.

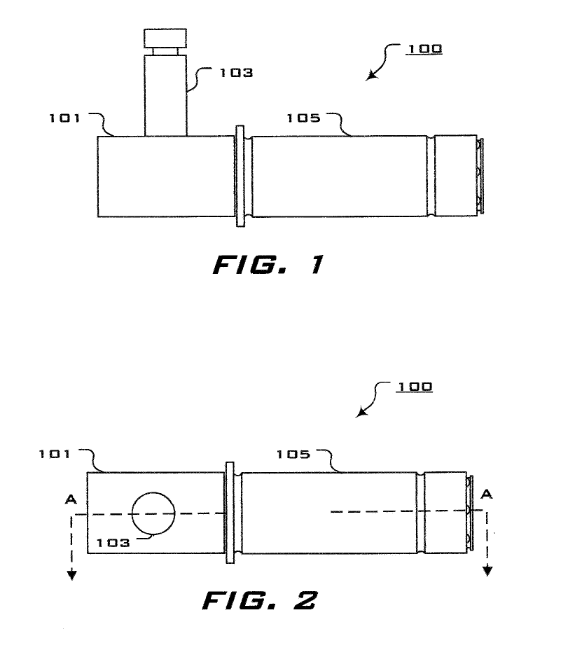

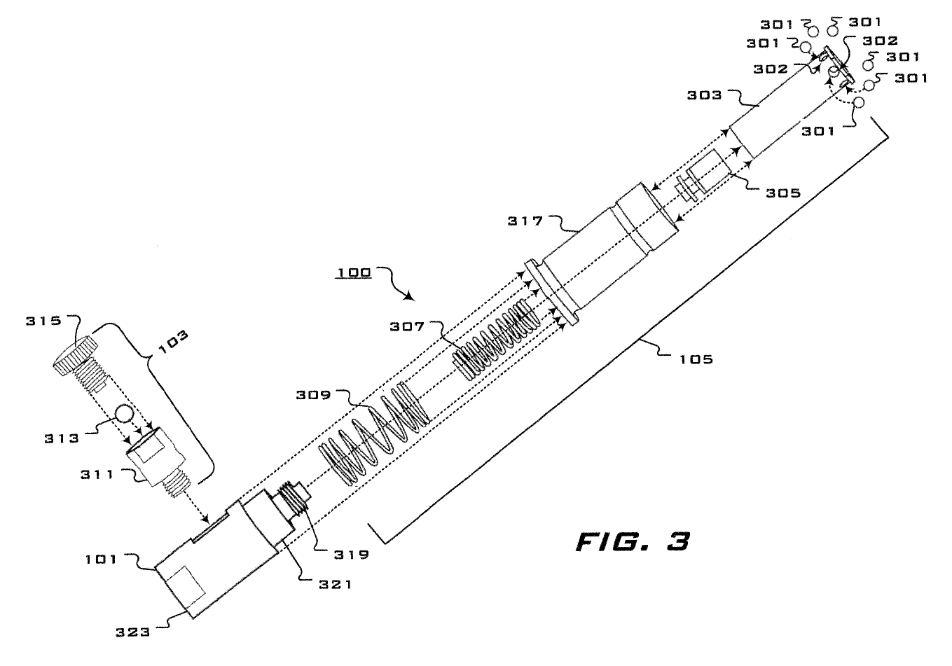

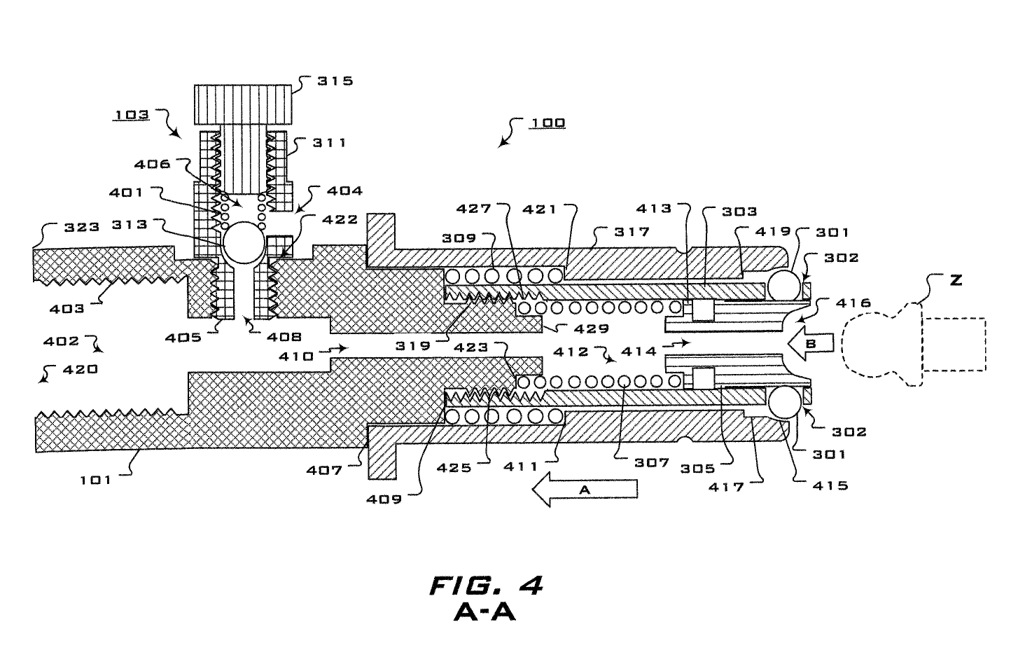

As generally shown in FIGS. 1 and 2, an exemplary grease gun coupler with integrated pressure relief valve 100 comprises a main body 101 to which is attached a pressure relief valve assembly 103 and a quick-release grease fitting coupler assembly 105. Referring to FIG. 3, main body 101 comprises generally cylindrical body with a rear end 323 which is configured to engage the nozzle of a grease gun (not shown) and a boss 321 extending from the front end, the boss 321 having a diameter less than that of the rearward portion of the main body 101. A threaded male portion 319 extends forward from the boss 321.

In FIG. 4, it can be seen that main body 101 is formed with a rear opening 420 defined in the rear end 323 and in communication with a cylindrical chamber 402 defined in the rear portion of the main body 101. The surface of the interior wall of the chamber 402 is threaded to form a female fitting for a grease gun nozzle (not shown). An opening 422 is defined in the top of the main body 101 with threaded interior walls to form a second female fitting for receiving a threaded male fitting 405 extending from the bottom of the pressure relief valve assembly 103. Chamber 402 is in fluid communication with a central bore 410 extending through the forward end of the main body 101. At the juncture from which the boss 321 extends from the rear portion of the main body 101 a first annular shoulder 407 is formed. Similarly, a second annular shoulder 409 is formed at the juncture between the front end of the boss 321 and front threaded male fitting 319. A third annular shoulder 423 is formed between the threaded male fitting 319 and a nipple 429 that extends forward therefrom.

Pressure relief valve assembly 103 includes a cylindrical housing 311 extending generally perpendicularly from the main body 100 and which defines an interior cylindrical chamber 406 in communication with a side port 404 that opens to the outside environment. The upper portion of the chamber 406 comprises female threaded interior surfaces dimensioned to receive a set screw 315. A ball is housed within chamber 406 and is biased against the lower part of the chamber 406 by a compression spring 401. The lower part of the chamber 406 is in communication with a conduit 408 that is defined in the threaded male fitting 405 that is dimensioned to be threadably engaged with the top opening 422 in the main body 101. It will be appreciated by those skilled in the relevant arts that the pressure relief valve assembly 103 shown is a ball valve. However, description directed to a ball valve is only illustrative. It will be understood that other pressure relief valves now known or hereafter developed may be suitable for use in the exemplary coupler 100.

The quick-release coupler assembly 105 comprises a cylindrical collar 317 in through which is defined an interior chamber. A cylindrical ball carrier 303 having a cylindrical chamber 412 defined therein and is housed within the collar 317 with the outer surface of the carrier 303 being in sliding engagement with the interior wall of the collar 317 such that the collar 317 may be moved axially with respect to the carrier 303. The interior surface of the collar 317 is formed with a rear-facing annular shoulder 421 opposing the second annular shoulder 409 of the main body 101. A compression member 309 is installed between the second main body annular shoulder 409 and the rear-facing annular shoulder 421 and surrounds the ball carrier 303. The compression member 309 biases the collar 317 forward with respect to the ball carrier 303, but allows the collar 317 to be drawn rearward. A forward-facing annular shoulder 419 is formed near the front end of the collar 317 with a forward interior wall 417 of greater diameter than the middle portion of the chamber 412. The forward interior wall 417 extends forward to a transition area 415 where the diameter of the interior surface of the collar 317 increases radially outward from the longitudinal axis.

Near the front end of the ball carrier 303, a plurality of openings 302 are defined in exterior wall of the carrier 303. The openings 302 receive a corresponding number of ball bearings 301 and are retained therein by engagement with the interior wall 417 and transition area 415 of the collar 317 near the front end thereof. The rear end of the carrier 303 comprises a threaded female opening 425 dimensioned for threaded engagement with the threaded male fitting 319 of the main body 101. Thus, the central bore 410 of the main body 101 is in fluid communication with the chamber 412 of the ball carrier 303. In some embodiments, the engagement of the main body 101 to the ball carrier 303 may be locked, in ways known in the art.

A cylindrical cup 305 is housed within the chamber 412 of the ball carrier 303 having an exterior surface in sliding engagement with the interior surface of the chamber 412 such that it is allowed to move axially with respect to the carrier 303. The cup 305 is formed with a longitudinal bore 414 extending therethrough opening to a recess 416 defined in its forward end. The rearward end of the cup 305 is configured with a flange 413 extending radially outward from the longitudinal axis of the cup 305 and defining a rear-facing surface opposing the third annular shoulder 423 of the main body 101. A third compression member 307 is seated in between the annular shoulder 423 and the flange 413 and biases the cup 305 forward but allows the cup 305 to be pushed rearward to some degree as will be described below.

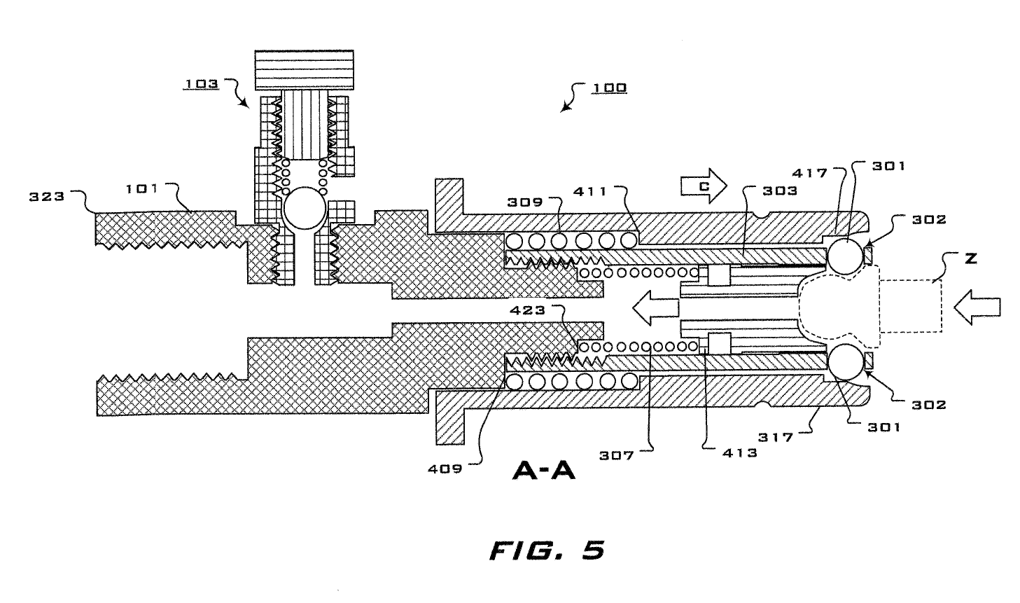

As shown in FIGS. 4 and 5, the coupler 100 is used by inserting a grease fitting Z into the recess 416 of the cup 305, urging the cup 305 rearward with respect to the ball carrier 303. Typical grease fittings Z, e.g., a Zerk fitting, Amelite fitting, or the like, comprise a bulbous head portion transitioning to a narrow neck. When the coupler 100 is not engaged with a fitting Z, the cup 305 is seated within the chamber 412 near the forward end thereof, maintained in this position by compression member 307 (FIG. 4). The circumferential surface of forward portion of the cup 305 pushes the ball bearings 301 radially outward but they are retained in their respective openings 302 by the interior wall 417 of the collar 317. As the fitting Z is inserted into recess 416 of the cup 305, the cup 305 is pushed rearward the bulbous head of the fitting Z travels past the openings 302 and the ball bearings 301 are pressed radially inward through engagement with the interior wall 417 of the collar 317 to engage the fitting's Z neck (FIG. 5) when the collar 317 is pressed forward by compression member 309. Thus, the fitting Z is locked to the coupler 100. To release the coupler 100 from the fitting Z, the collar 317 is drawn back (FIG. 4, reference arrow A) until the ball bearings 301 are clear of the interior wall 417 of the collar 317. Compression member 307 urges the cup 305 forward and pushes the ball bearings 301 radially outward into the transition area 415 of the collar 317, disengaging the ball bearings 301 from the neck of the fitting Z and allowing the fitting Z to uncouple from the coupler 100.

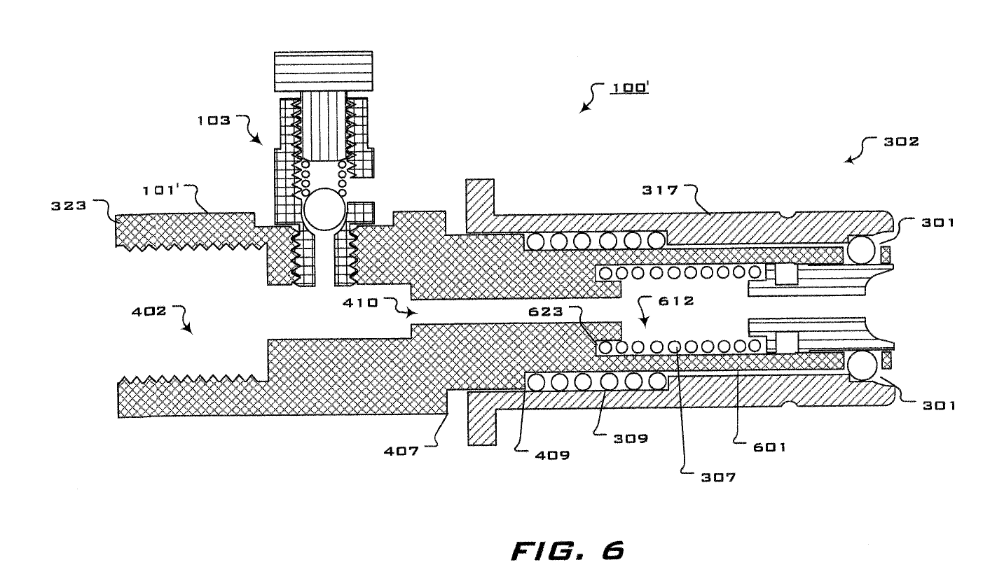

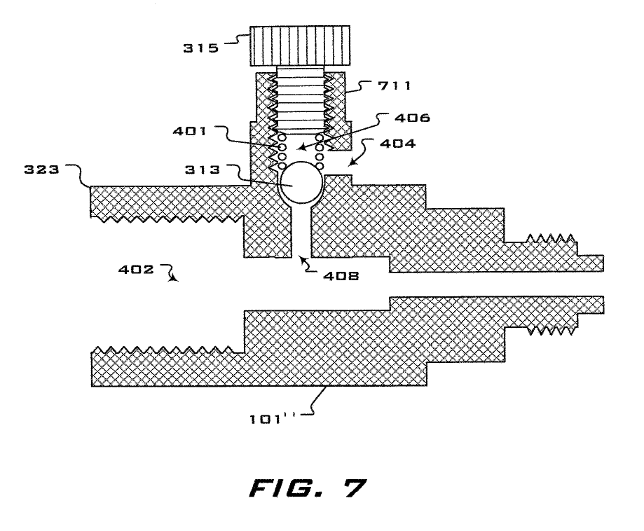

With reference now to FIG. 6, an alternative embodiment of the coupler 100′ is depicted having a main body 101′ with an integrally formed cylindrical forward extension 601 in which is defined a cylindrical chamber 612. A forward-facing annular shoulder 623 is formed within the chamber 612 against which the rearward end of compression member 307 is seated. Near the forward end of the extension 601 a plurality of openings 302 are defined in the surface thereof distributed circumferentially around the extension 601 and a corresponding number of ball bearings 301 are retained therein as described above. Accordingly, the main body 101′ in this embodiment comprises an integral ball carrier. A further alternative embodiment, illustrated in FIG. 7, includes a main body 101″ having an integrally formed pressure relief valve housing 711 extending from the top of the body 101″.

As described above and shown in the associated drawings, the present invention comprises a grease gun coupler with integrated pressure relief valve. While particular embodiments have been described, it will be understood, however, that any invention appertaining to the apparatus described is not limited thereto, since modifications may be made by those skilled in the art, particularly in light of the foregoing teachings. It is, therefore, contemplated by the appended claims to cover any such modifications that incorporate those features or those improvements that embody the spirit and scope of the invention.

What is claimed is:

1. A grease gun coupler for coupling a grease gun to a grease fitting comprising:
a generally cylindrical body comprising:
a first end having a first diameter and configured with a threaded female opening dimensioned to receive a threaded male nozzle of a grease gun;
a boss extending distally from said first end, said boss having a second diameter that is less than said first diameter forming a first annular shoulder;
an elongated portion extending from said boss away from said first end having a third diameter that is less than said second diameter forming a second annular shoulder and a distal end configured with a plurality of openings defined in the circumferential wall for receiving a corresponding plurality of ball bearings;
a pressure relief valve extending generally perpendicularly from said body; and
a generally cylindrical chamber defined through the body along the longitudinal axis thereof extending from said threaded female opening to said distal end and configured with a third annular shoulder having a diameter less than that of said second annular shoulder;
a cylindrical collar configured with a generally cylindrical chamber defined axially therethrough and configured with a first portion oriented toward said first end and having a first inside diameter dimensioned to slidably engage said boss, and a second portion having a second inside diameter, said second inside diameter dimensioned to slidably engage said elongated portion such that an opposing annular shoulder is formed facing said second annular shoulder;
a first biasing member for biasing said collar toward said distal end interposed between said second annular shoulder and said opposing annular shoulder;
a grease fitting cup slidably engaged within said generally cylindrical chamber inside said elongated portion, said cup configured with a central bore oriented co-axially with said cylindrical chamber and having an open end comprising a recess, and an annular flange opposing said third annular shoulder of said body; and
a second biasing member for biasing said grease fitting cup toward said distal end interposed between said third annular shoulder and said annular flange.

2. The grease gun coupler of claim 1, wherein said pressure relief valve is a ball valve.

3. The grease gun coupler of claim 1, wherein said elongated portion is detachable from said body.

4. The grease gun coupler of claim 1, wherein said pressure relief valve is detachable from said body.

5. An assembly comprising:
a coupler configured to attach a grease gun to a grease fitting and having a main body and a fluid conduit defined therethrough; and
a pressure relief valve integrally formed with said main body extending generally perpendicularly therefrom and having a fluid chamber in communication with said fluid conduit.

6. The assembly of claim 5, wherein said coupler is a quick-release coupler.

7. The assembly of claim 5, wherein said coupler is detachable from said main body.
